(19) United States
(12) Patent Application Publication
(10) Pub. No.: US 2017/0226011 A1
(43) Pub. Date: Aug. 10, 2017

(54) ADDITIVE FOR GRINDING ON ROLLING MILLS

(71) Applicant: SIKA TECHNOLOGY AG, Baar (CH)

(72) Inventors: Thomas MÜLLER, Heidelberg (DE); Matthias DIETRICH, Rapperswil (CH)

(73) Assignee: SIKA TECHNOLOGY AG, Baar (CH)

(21) Appl. No.: 15/514,667

(22) PCT Filed: Oct. 2, 2015
(86) PCT No.: PCT/EP2015/072832

§ 371 Date: Mar. 27, 2017

(30) Foreign Application Priority Data
Oct. 6, 2014 (EP) 14187787.8

(51) Int. Cl. C04B 24/02; C04B 40/00; C04B 7/52

(52) U.S. Cl. CPC C04B 24/02; C04B 7/52; C04B 40/0039; C04B 2103/52

(57) ABSTRACT

At least one glycol compound is used as a grinding aid when grinding at least one solid substance, in particular an inorganic and/or mineral solid substance, in a rolling mill, wherein the at least one glycol compound has a structure according to formula I: (formula 1) and wherein a) R1, R2, R3 each independently of one another stand for H or an alkyl, alkoxy or alkanol group with 1-8 carbon atoms, in particular with 2-4 carbon atoms; and b) X stands for a substituted or unsubstituted alkylene group with 1-8 carbon atoms, in particular 1-4 carbon atoms.

### TECHNICAL FIELD

The invention relates to the use of at least one glycol compound as grinding aid in the grinding of a solid, more particularly of an inorganic and/or mineral solid. The invention pertains, moreover, to compositions comprising glycol compounds and also to a method for grinding a solid.

### PRIOR ART

A central step and substantial cost factor in the production of mineral binders, especially cement, is the grinding of the coarse-particle mineral components into fine powder. In cement production, then, for example, clinker and optionally, depending on the type of cement being produced, additions as well, such as blast-furnace sand or limestone, for example, are ground to fine powder. Cement and additions here may in principle be ground together or else separately.

The fineness of the mineral binder is an important quality feature here. For example cured mortar or concrete mixtures containing finely ground mineral binders generally have higher compressive strengths than similar mixtures based on more coarsely ground mineral binders.

In order to make it easier to comminute mineral binders in mills, and to prevent agglomeration of the resulting pulverulent particles, it is possible to use what are known as grinding aids. They bring about a sharp reduction in the expenditure of energy required for grinding. Established as grinding aids from the 1960s onward have been organic substances, especially glycols and amino alcohols, and also mixtures of these. They are added to the cement mill in amounts of up to about 0.1%, based on the grinding stock, together with the latter. As a result, for a given fineness or identical Blaine value of the cement, the mill throughput can be increased by 20 to 30%, and in some systems even by up to 50%.

In this connection, U.S. Pat. No. 5,084,103 (David F. Myers, W.R. Grace & Co.) describes, for example, grinding aids based on higher trialkanolamines such as triisopropanolamine, N,N-bis(2-hydroxyethyl)-N-2-hydroxypropyl)amine, and tris(2-hydroxybutyl)amine.

There exist various types of mills, differing in construction and mode of action. It has now being ascertained that certain grinding aids which function well on one type of mill produce no satisfactory effect on other types of mill.

Especially for roller mills, in which at least one grinding tool is rollably arranged on a substantially horizontally rotatable grinding plate or grinding bowl, there continues to be a need for improved grinding aids.

### SUMMARY OF THE INVENTION

It is an object of the invention, therefore, to provide an improved additive for the grinding of solids, more particularly of inorganic and/or mineral solids, specifically of cementitious binders, in a roller mill. The additive is to improve the grinding operation in a roller mill. In particular, the additive is to be useful as a grinding aid and is to boost the grinding efficiency or productivity in the grinding of solids, especially mineral binders, in roller mills.

Surprisingly it has been found that the object of the invention can be achieved in accordance with claim 1 by using at least one glycol compound as grinding aid in the grinding of at least one solid, more particularly of an inorganic and/or mineral solid, in a roller mill, the at least one glycol compound having a structure as per formula I.

As has surprisingly emerged in roller mill grinding trials, it is possible, in comparison with other known additives, to achieve increased grinding efficiency or productivity in the grinding of solids, using the glycol compounds of the invention. This is especially the case for mineral binders, specifically for cementitious binders. For a given level of addition and given productivity, therefore, using the glycol compounds in the grinding of solids, especially mineral solids, it is possible to obtain a much finer powder with substantially greater specific surface area and/or greater Blaine value. Conversely, for a given level of addition, it is possible to increase the productivity if the fineness of the ground powder remains constant. It is possible, moreover, to increase both the productivity and the fineness of the powder. It is also possible, moreover, for the sieve residue to be significantly reduced.

It has also emerged, surprisingly, that the glycol compounds used in accordance with the invention lead to a significant reduction in vibrations in roller mills and also have the effect of stabilizing the grinding bed.

The glycol compounds can be used generally as additives in the grinding of different mineral binders. These may be, in particular, cementitious binder such as, for example, any of a wide variety of cement grades (CEM I, CEM II, CEM III, CEM IV, CEM V, so-called “green cements” and belite cement) for ready-mixed concrete, in-situ concrete, precast-component concrete, and shotcrete, and also for mortar applications such as repair mortars, grouts, spray-applied mortars or the like. Adding the glycol compounds of the invention has hardly adverse effect, or none at all, on the processing qualities of the mineral binders.

Furthermore, the glycol compounds of the invention are also compatible with a host of other common additives and process chemicals used in the grinding of solids. The glycol compounds can therefore be employed flexibly in the grinding of solids.

Further aspects of the invention are subjects of further independent claims. Particularly preferred embodiments of the invention are subjects of the dependent claims.

### Certain Embodiments of the Invention

A first aspect of the present invention relates to the use of at least one glycol compound as grinding aid in the grinding of at least one solid, more particularly of an inorganic and/or mineral solid, in a roller mill, the at least one glycol compound having a structure as per formula I:

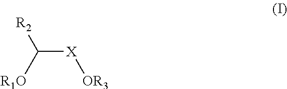

where
a) R¹, R², and R³ each independently of one another are H or an alkyl, alkoxy or alkanol group having 1-8 carbon atoms, more particularly having 2-4 carbon atoms; and
b) X is a substituted or unsubstituted alkylene group having 1-8 carbon atoms, more particularly 1-4 carbon atoms.

The term “grinding” or “grinding operation” refers in particular to a process in which an average particle size of a solid or of a mixture of different solids is reduced. This takes place presently in a roller mill in the grinding of clinker, optionally together with inert and/or active additions, such as, for example, with gypsum, anhydrite, α-hemihydrate, β-hemihydrate, latent hydraulic binders, pozzolanic binders and/or inert fillers. In grinding, the solid or mixture of different solids, more particularly a mineral binder, is typically ground to a Blaine value of at least 500 cm²/g, more particularly at least 1000 cm²/g, preferably at least 1500 cm²/g, more preferably at least 2000 cm²/g. The grinding operation or the grinding of the solid takes place in particular at temperatures below 300° C., preferably below 250° C., more preferably below 150° C. Particularly preferred temperatures are between 30-150° C., more particularly 60-120° C.

A “solid” in the present context is more particularly an inorganic and/or mineral solid. The solid in particular is an inorganic substance for construction use, as a constituent for cement, mortar and/or concrete compositions, for example. The solid is preferably a mineral binder and/or an adjuvant for a mineral binder. The solid may be present fundamentally in a coarse form, as (unground) clinker, for example, and/or may already have been partly ground.

A “mineral binder” is, in particular, a binder, more particularly an inorganic binder, which reacts in the presence of water, in a hydration reaction, to form solid hydrates or hydrate phases. It may be, for example, a hydraulic binder (e.g. cement or hydraulic lime), a latent hydraulic binder (e.g. slag or blast furnace sand), a pozzolanic binder (e.g. flyash, trass or rice husk ash) and/or a nonhydraulic binder (gypsum or white lime). Mixtures of the various binders are also possible.

An “adjuvant for a mineral binder” is, for example, an inert mineral substance such as limestone, finely ground quartz and/or pigments, for example.

A “cementitious binder” is presently understood to refer in particular to a binder or binder composition having a cement clinker fraction of at least 5 wt %, more particularly at least 20 wt %, preferably at least 35 wt %, especially at least 65 wt %.

A “roller mill” is a mill in which a grinding tool is rollably arranged on a substantially horizontally rotatable grinding plate or grinding bowl. The term “roller mill” presently includes “roll mills”, “vertical mills”, and “vertical roller mills”. The grinding tool used may comprise, for example, a cylindrical, conical or spherical roll, a roller or a ball. These tools are mounted rotatably, in particular via special mounting devices.

During grinding in the roller mill, the grinding stock is applied to the grinding plate, and it passes between grinding plate and grinding tool, being comminuted in the process. With roller mills, then, the grinding stock is comminuted by having the grinding tool rolling over it.

In particular, the grinding stock is placed on to the grinding plate centrally from above and is conveyed by means of centrifugal forces, for example, into the region of the grinding tools. The ground stock may be conveyed on via a peripheral region of the grinding plate, from which it may be transported off with a stream of air, for example, to a classifier, for example.

The pressing of the grinding tools on to the grinding stock (i.e., grinding pressure) may be regulated or generated by the gravity of the grinding tools or by additional pressure, hydropneumatically, for example.

There are various designs of roller mills. The roller mill is, in particular, a Loesche roll mill, a ring-ball mill, a Raymond spring roller mill, an MPS roller mill or a Polysius roller mill. Mills of these kinds are described in detail in “Cement Data Handbook” (Walter H. Duda), volume 1, Internationale Verfahrenstechniken der Zementindustrie, 3rd edition, Bauverlag GmbH (Wiesbaden and Berlin).

Roller mills should not be confused with grinding media mills, such as ball mills, for example. With grinding media mills, grinding stock and freely mobile grinding media are revolved in a process chamber. During this operation there are impacts between the grinding media, the walls of the process chamber, and the grinding stock. The grinding stock in this case is comminuted in particular by fragmentation and not by a rollover process.

Downstream of the roller mill in particular is a device for the size separation of particulate solids, such as a pneumatic classifier, centrifugal classifier, gravity classifier, measuring cyclone, jet diversion classifier, impactor or flat classifier, for example. The classifier is often sited inside the mill housing. With a pneumatic classifier, the particulate solids are separated according to the ratio of flow resistance, gravity and/or centrifugal force in a stream of gas.

Here, advantageously, particulate solids which exceed a predetermined size or cutoff limit are passed back out of the size separation device to the roller mill again. This may take place, in particular, during operation and continuously. The interaction between roller mill and device for size separation of particulate solids allows particularly efficient production of ground particulate solids with defined particle size distribution, therefore.

In one advantageous embodiment of the invention, the at least one glycol compound is used as grinding aid for improving the grinding efficiency in the grinding of a mineral substance, more particularly in the grinding of a mineral binder. The glycol compounds have proven themselves particularly suitable as grinding aids in the grinding of cementitious binders or cement clinkers.

The effect of the at least one glycol compound is, in particular, to boost the productivity of the roller mill and/or to increase the fineness of grind. In comparison with known additives, increased grinding efficiency and/or productivity in the grinding of solids are achieved with the glycol compounds of the invention. This is true in particular for mineral binders, especially cementitious binders. For a given level of addition, therefore, in the grinding of solids, especially mineral solids, with the glycol compounds, it is possible to obtain a significantly finer powder having substantially greater specific surface area or higher Blaine value. Furthermore, the sieve residue can be significantly reduced as well.

The at least one glycol compound may preferably also be used for reducing vibration or oscillation of the roller mill. The at least one glycol compound may equally be used advantageously for stabilizing the grinding bed of the roller mill as well.

Vibrations occur in roller mills especially when the grinding stock is unevenly distributed on the grinding plate, when unusually hard contaminants reach the grinding plate, or when the amount of grinding stock is too great. The “grinding bed” refers to grinding stock lying on the grinding plate.

It has been found that the glycol compounds of the invention are able to achieve significant reduction in unwanted vibrations during operation of the roller mill. This is a surprise, since other grinding aids do in some cases improve the productivity or grinding efficiency, but have no notable effect in reducing mill vibrations.

The glycol compounds of the invention also are able to stabilize the grinding bed. Stabilization of the grinding bed here means, in particular, the optimization of the grinding stock distribution or of the grinding bed on the grinding plate, to achieve an optimum grinding effect. This is a beneficial factor in reducing unwanted vibration. Water has to date usually been used for this purpose. Using water, however, particularly when grinding hydraulic or cementitious binders, has the drawback that some of the grinding stock reacts with the water during grinding, to form hydrate phases, and no longer acts as a settable hydraulic or cementitious binder.

If, on the other hand, a glycol compound of the invention is used, it is possible to reduce or eliminate entirely the jetted introduction of water that is necessary for grinding bed stabilization. This allows an improvement in grinding stock quality to be obtained. And this is achievable in particular without the risk of hydration reactions with hydraulic or cementitious binders. The physical properties of the solid are therefore improved directly.

Additionally it has been found that when using the glycol compounds of the invention in the grinding operation, it is possible to improve the Pack-Set Index in accordance with standard ASTM C1565:2009. The glycol compounds of the invention, accordingly, can be used specifically for that purpose.

It is likewise possible to use the at least one glycol compound simultaneously as grinding aid and as aid to improving the physical properties of the solid. This is so in particular with cementitious binders.

As has been found, the use of the at least one glycol compound is especially advantageous if the solid comprises or consists of a hydraulic binder, preferably cement and/or cement clinker. Particularly preferred cement is a cement having a cement clinker fraction of 35 wt %. The cement more particularly is of type CEM I, CEM II and/or CEM IIIA (as per standard EN 197-1). The proportion of the hydraulic binder in the solid as a whole is advantageously at least 5 wt %, more particularly at least 20 wt %, preferably at least 35 wt %, especially at least 65 wt %. According to a further advantageous embodiment, the solid consists of 95 wt % of hydraulic binder, more particularly cement clinker.

Also possible for example, however, are uses where the solid comprises or consists of other binders. These are, in particular, latent hydraulic binders and/or pozzolanic binders. Examples of suitable latent hydraulic and/or pozzolanic binders are slag and/or flyash. In one advantageous embodiment the solid contains 5-95 wt %, especially 5-65 wt %, more preferably 15-35 wt % of latent hydraulic and/or pozzolanic binders. Also possible are 95 wt % of latent hydraulic and/or pozzolanic binders in the solid.

The glycol compound may also be used in the grinding of inert solids, examples being mineral substances, especially finely ground limestone, finely ground quartz and/or pigments.

Also advantageous in particular is the use of the glycol compound with solids which comprise a mixture of a hydraulic binder, more particularly cement clinker, and a latent hydraulic and/or pozzolanic binder, preferably slag and/or flyash. The fraction of the latent hydraulic and/or pozzolanic binder in this case is in particular 5-95 wt %, more preferably 5-65 wt %, especially preferably 15-35 wt %, while there is at least 35 wt %, especially at least 65 wt %, of the hydraulic binder. Additionally present in the mixture, furthermore, may be an inert substance, limestone for example. Such mixtures, after grinding, may be used for example as binder components in mortar mixtures and concrete mixtures.

The glycol compound is added to the solid before and/or during an operation of grinding on the solid. In one preferred embodiment the addition takes place before the grinding operation.

The glycol compound may be used, for example, as pure substance, in particular with a purity of 95 wt %.

The glycol compound is used advantageously in liquid form, more particularly as a solution or dispersion. Preferred are aqueous solutions and/or dispersions with a glycol compound fraction of 5-99 wt %, preferably 20-80 wt %, more particularly 30-70 wt %. Optimum mixing with the grinding stock is achieved with such proportions.

In principle, however, the glycol compound may also be used in solid form for example, applied to a solid carrier material or, where possible, in the form of powder, pellets or flakes.

In reference to the at least one glycol compound, the expression “substituted or unsubstituted alkylene group having 1-8 carbon atoms” or X in formula I is presently, in particular, an alkylene group of the formula —(CH₂)ₙ— where n=1-8, it being possible optionally for one or more hydrogen atoms, independently of one another, to be substituted by an alkyl, alkoxy or alkanol group. Preferred substituents are alkyl groups. The total number of carbon atoms in the substituted or unsubstituted alkylene group is in the 1-8, more particularly 1-4, especially 1-2 range.

X may also be an oxyalkylene group or an alkoxy group, more particularly —(O—CH₂—CH₂)ₙ— or —(O—CH(CH₃)—CH₂)ₙ— or —(O—CH₂—CH(CH₃)ₙ—, in particular with n=1-4, especially 1-2.

More particularly, X is a substituted or unsubstituted alkoxy group having 1-8 carbon atoms.

If X is a substituted alkylene group, X is preferably an alkylene group based on the formula —(CH₂)ₙ— with n=1-2, with one or two of the hydrogen atoms substituted independently of one another by an alkyl group. This alkyl group contains preferably 1-4 or 1-2 carbon atoms.

With advantageous glycol compounds, R¹ and R² in formula I each independently of one another are H, CH₃ or C₂H₄OH, more particularly H or CH₃.

R³ in formula I is preferably H, C₃H₆OH or C₄H₉.

More preferably the at least one glycol compound is selected from the group consisting of ethylene glycol, diethylene glycol, propylene glycol, dipropylene glycol, butyl diglycol, neopentyl glycol, and hexylene glycol.

Propylene glycol has in particular a structure as per formula II:

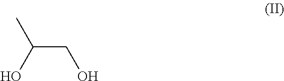

Formula II in this case corresponds to formula I with R₁═H, R₂ ═CH₃, R₃═H, X═CH₂.

Dipropylene glycol may be present in particular in the form of structures according to formulae III, IV and/or V:

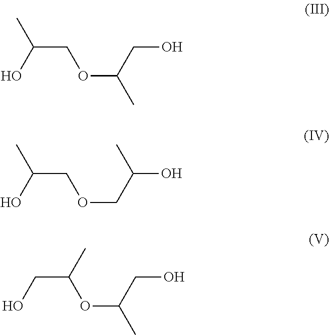

Formula III in this case corresponds to formula I with R₁═H, R₂═CH₃, R₃═CH(CH₃)CH₂OH, X═CH₂.

Formula IV in this case corresponds to formula I with R₁═H, R₂═CH₃, R₃═CH₂CH(CH₃)OH, X═CH₂.

Formula V in this case corresponds to formula I with R₁═H, R₂═H, R₃═CH(CH₃)CH₂OH, X═CH(CH₃).

Butyl diglycol, neopentyl glycol, and hexylene glycol possess, in particular, structures as per formulae VI (butyl diglycol), VII (neopentyl glycol), and VIII (hexylene glycol):

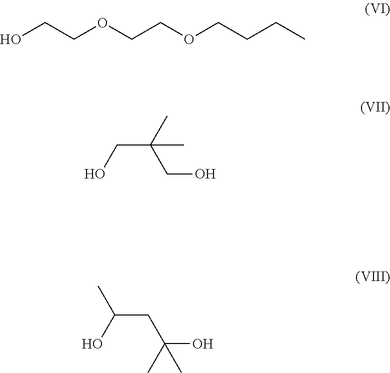

Formula VI corresponds to formula I with R₁═C₂H₄OH, R₂═H, R₃═C₄H₉, X═CH₂.

Formula VII in this case corresponds to formula I with R₁═H, R₂═H, R₃═H, X═C(CH₃)₂CH₂.

Formula VIII in this case corresponds to formula I with R₁═H, R₂═CH₃, R₃═H, X═CH₂C(CH₃)₂.

With particular advantage the at least one glycol compound is selected from diethylene glycol, propylene glycol, dipropylene glycol, butyl diglycol, neopentyl glycol, and hexylene glycol. In particular it is diethylene glycol, propylene glycol, dipropylene glycol, butyl diglycol. Especially preferred are propylene glycol, dipropylene glycol, and butyl diglycol.

The at least one glycol compound especially is selected from dipropylene glycol and butyl diglycol.

As has surprisingly emerged, these substances achieve particularly effective vibration reduction of the roller mill.

In principle, however, other glycol compounds can also be used.

With advantage the at least one glycol compound is used in an amount of 0.001-1 wt %, more particularly 0.02-0.5 wt %, based on the weight of the solid. Fractions of 0.005-0.4 wt %, more particularly 0.02-0.3 wt %, have proven particularly suitable here.

It has emerged that with fractions of this kind, the productivity and/or grinding efficiency are/is significantly improved, and/or the physical properties of the ground solid can be markedly enhanced. Other fractions, however, are also possible in principle.

In another advantageous embodiment, the at least one glycol compound is used in combination with at least one further additive. The at least one further additive is chemically distinguishable from the at least one glycol compound.

In principle here it is possible to use a host of substances known to the person skilled in the art to act in particular as grinding aids and/or admixtures for binder compositions, such as, for example, concrete admixtures and/or mortar admixtures. The further additive is selected more particularly from the group encompassing grinding aids, defoamers, dyes, preservatives, plasticizers, superplasticizers, accelerators, retarders, air entrainers, shrinkage reducers and/or corrosion inhibitors.

More particularly the at least one additive comprises grinding aids, defoamers, dyes, preservatives, plasticizers, superplasticizers, accelerators, retarders, air entrainers, shrinkage reducers and/or corrosion inhibitors for mineral binders, mortar compositions and/or concrete compositions.

The further additive is advantageously used in an amount of 0.001-10 wt %, more particularly 0.005-5 wt %, preferably 0.01-2 wt % or 0.05-1 wt %, based on the weight of the solid.

The further additive is used advantageously in the liquid aggregate state. In this way, more effective distribution and wetting of the solids can be achieved. The further additive may be present in the form, for example, of solution or dispersion. In particular as aqueous solution or dispersion.

In principle, however, it is also possible for further additive to be used as a melt or in a solid aggregate state, in the form of powder, pellets or flakes, for example.

The further additive is added to the solids in particular before and/or during the operation of grinding these solids. In one advantageous embodiment, it is mixed prior to use with the at least one glycol compound. This facilitates addition and metering.

Also possible, however, is the separate addition of further additive and of the at least one glycol compound.

The at least one further additive advantageously constitutes a plasticizer. This includes, especially, a polycarboxylate, more particularly a polycaboxylate ether. The plasticizer in particular is a comb polymer comprising a polycarboxylate backbone with polyether side chains bonded thereon. The side chains are bonded to the polycarboxylate backbone in particular via ester, ether and/or amide groups.

Corresponding polycarboxylate ethers and preparation processes are disclosed for example in EP 1 138 697 B1 on page 7 line 20 to page 8 line 50, and also in its examples, or in EP 1 061 089 B1 at page 4, line 54 to page 5 line 38, and also in the examples thereof. In a variation thereof, as described in EP 1 348 729 A1 at page 3 to page 5 and also in the examples thereof, the comb polymer can be produced in the solid aggregate state. The disclosure content of these stated patent specifications is hereby included in particular by reference.

Comb polymers of this kind are also sold commercially by Sika Schweiz AG under the trade name series ViscoCrete®.

If present, the plasticizer, based on the solid, which in particular is a mineral binder, has a fraction advantageously of 0.01-6 wt %, more particularly 0.1-4 wt %, more preferably 0.5-3 wt %. On the basis of the combination with the plasticizer, it is possible to improve the processing qualities of a binder composition, with higher compressive strengths being achieved at the same time.

With particular advantage the further additive comprises one or more of the following representatives:
a) one or more amino alcohols and/or salts thereof,
b) one or more glycols and/or glycol derivatives, which differ in particular from the at least one glycol compound of formula I,
c) one or more polycarboxylates and/or polycarboxylate ethers.

Advantageous further amino alcohols are, in particular, trialkanolamines and/or dialkanolamines. Preference is given to triisopropanolamine, triethanolamine and/or diethanolamine.

Likewise advantageous as further amino alcohols are diisopropanolamine (DiPA) and/or N-methyldiethanolamine (MDEA). As has emerged, the glycol compounds of the invention are generally of high compatibility with these representatives of further additives. Accordingly, for example, a flexible adaptation to specific uses and/or a cost-based optimization in the production of the additives can be realized.

Examples of suitable polycarboxylate ethers in this context are the polymers described in WO2005/123621 A1, which likewise act as grinding aids.

A further aspect of the present invention relates to a method for grinding a solid, more particularly an inorganic and/or mineral solid, the solid to be ground being admixed, before and/or during grinding, with at least one glycol compound and being ground in a roller mill.

Likewise a subject of the invention is a composition which is obtainable by the method described above. The composition in particular comprises a solid, preferably an inorganic and/or mineral solid, which has been ground together with the at least one glycol compound in a roller mill.

The at least one glycol compound, the solid, and the roller mill are defined as described above. In particular, the at least one glycol compound is selected from the group consisting of ethylene glycol, diethylene glycol, propylene glycol, dipropylene glycol, butyl diglycol, neopentyl glycol, and hexylene glycol.

Preferred are propylene glycol, dipropylene glycol, butyl diglycol, neopentyl glycol, and hexylene glycol. Even further preferred are propylene glycol, dipropylene glycol, and butyl diglycol, especially dipropylene glycol and butyl diglycol.

The present invention additionally relates to a grinding aid composition comprising:
a) at least one glycol compound, the at least one glycol compound being defined as above,
   and
b) at least one further additive which is selected from the group encompassing grinding aids, defoamers, dyes, preservatives, plasticizers, superplasticizers, accelerators, retarders, air entrainers, shrinkage reducers and/or corrosion inhibitors,
   the at least one further additive being chemically distinguishable from the at least one glycol compound.

The at least one glycol compound and the at least one further additive are defined as described above. In particular the at least one further additive comprises a polycarboxylate ether and/or amino alcohol as described above.

One particularly preferred grinding aid composition comprises or consists of:
a) 5-99 wt %, preferably 5-80 wt %, more preferably 5-50 wt % of the at least one glycol compound;
b) 1-80 wt %, preferably 5-60 wt %, more preferably 5-30 wt % of the at least one additive;
c) 0-90 wt %, more particularly 1-20 wt %, of at least one further component;
d) 0-90 wt %, more particularly 10-60 wt %, of water.

Grinding aid compositions of this kind have proven themselves to be particularly suitable for uses with roller mills.

Likewise a subject of the invention is a composition comprising a solid, more particularly an inorganic and/or mineral solid, and also at least one glycol compound. The glycol compound and the solid are defined as described above. In particular the solid comprises or consists of a mineral binder. With particular preference the solid comprises a mineral binder, and the at least one glycol compound is selected from diethylene glycol, propylene glycol, dipropylene glycol, butyl diglycol, neopentyl glycol, and hexylene glycol. In particular it is diethylene glycol, propylene glycol, dipropylene glycol, butyl diglycol. Especially preferred are propylene glycol, dipropylene glycol, and butyl diglycol.

The composition is obtainable, for example, by mixing the at least one glycol compound with the solid by means of a method as described above or by a use as described above.

Further advantageous embodiments of the invention are apparent to the person skilled in the art from the working examples which follow.

### WORKING EXAMLPES

1. Additives Used

Additives A1-A7 below were used for the working examples (Table 1):

TABLE 1

| Designation | Composition |
|---|---|
| A1 | Ethylene glycol |
| A2 | Diethylene glycol |
| A3 | Propylene glycol |
| A4 | Dipropylene glycol |
| A5 | Butyl diglycol |
| A6 | Neopentyl glycol |
| A7 | Hexylene glycol |

All of the substances A1-A7 listed in Table 1 are available commercially from various suppliers and were used in pure form (purity >97%).

2. Laboratory Ball Mill Grinding Trials (Comparative)

For purposes of comparison, the activity of the various additives A1-A7 as grinding aids was investigated on a laboratory ball mill.

In grinding trials 1_1-L7, 300 g of a cement clinker were ground under identical conditions on a laboratory ball mill with each of the additives specified in Table 2. Trial L0 is a reference sample without additive. The levels of addition of additives A1-A7 were consistently 0.02 wt % (amount of pure additive, based on cement clinker). The grinding time was kept constant for all of the grinding trials.

When the grinding operation had taken place, the Blaine fineness and also the sieve residue of the particles above 32 μm (in wt %, based on all of the particles) were determined in analogy to standard EN 196-6 (May 2010) using a 32 μm sieve.

Table 2 provides an overview of the grinding trials conducted and of the corresponding results.

TABLE 2

| Trial | L0 | L1 | L2 | L3 | L4 | L5 | L6 | L7 |
|---|---|---|---|---|---|---|---|---|
| Additive | — | A1 | A2 | A3 | A4 | A5 | A6 | A7 |
| Fineness in % | 100 | 132 | 146 | 148 | 139 | 141 | 140 | 151 |
| relative to L0 | | | | | | | | |
| Sieve residue | 100 | 78 | 69 | 66 | 71 | 71 | 72 | 66 |
| >32 μm in % | | | | | | | | |
| relative to L0 | | | | | | | | |

From Table 2 it is apparent in particular that the greatest fineness and also the smallest sieve residue are achieved when using additive A7 (trial L7).

With regard to fineness, therefore, the ranking list is as follows (higher values are better): A7>A3>A2>A5>A4>A1. With regard to fineness, accordingly, the ranking list is essentially the same (lower values are better): A7=A3<A2<A5=A4<A1.

3. Roller Mill Grinding Trials

The various additives A1-A7 were then used as grinding aids on a roller mill with downstream classifier. The roller mill was operated so as to grind the cement clinker to a constant specific Blaine surface area of 4200 cm²/g. For the determination of the grinding efficiency and/or the effect of the grinding aids, the production quantity of ground cement per unit time (in metric tons per hour) was measured. Additionally, the vibrations during the grinding operation were ascertained.

The mill was operated with the following parameters:
Grinding plate rotary speed: 98 revolutions/min
Grinding pressure: 150 bar
Classifier speed: 650 revolutions/min
Fresh air supply: 480 m³/h
Temperature (after classifier): 90° C.

Table 3 provides an overview of the grinding trials conducted and of the corresponding results (R0 is a reference sample without additive).

TABLE 3

| Trial | R0 | R1 | R2 | R3 | R4 | R5 | R6 | R7 |
|---|---|---|---|---|---|---|---|---|
| Additive | — | A1 | A2 | A3 | A4 | A5 | A6 | A7 |
| Productivity in % | 100 | 116 | 118 | 119 | 121 | 118 | 115 | 120 |
| relative to | | | | | | | | |
| R0 | | | | | | | | |
| Vibration | 10 | 10 | 6 | 4 | 3 | 4 | 8 | 8 |
| [mm/s] | | | | | | | | |

Table 3 shows clearly that additives Al-A7 are suitable grinding aids for roller mills and produce an increase in the productivity or grinding efficiency. Scoring particularly well in these trials are the additives A3 (propylene glycol), A4 (dipropylene glycol), and A7 (hexylene glycol).

With regard to productivity, therefore, the ranking list is as follows (higher values are better): A4>A7>A3>A5=A2>A1>A6.

Particularly surprising are the vibration values observed: the additives A3 (propylene glycol), A4 (dipropylene glycol), and A5 (butyl diglycol) produce particularly high reductions in the unwanted vibrations.

With regard to vibration, therefore, the ranking list is as follows (lower values are better): A4<A5=A3<A2<A6<A7<A1. This sequence is clearly different from the above-recited sequence relating to the productivity.

A comparison with the results from Table 2 shows that the same grinding aids act completely differently in grinding media mills (e.g., ball mills) than in roller mills.

Hence it has been shown, in particular, that through the use of a glycol compound as grinding aid in the grinding of solids, especially in cementitious binders, in a roller mill, it is possible to achieve a massive boost to the productivity and a significant reduction in mill vibration.

The embodiments described above should be understood, however, merely as illustrative examples, which may be modified as desired within the bounds of the invention.

1. A method for grinding, comprising grinding of at least one solid in the presence of at least one glycol compound, as a grinding aid, in a roller mill, the at least one glycol compound having a structure as per formula I: 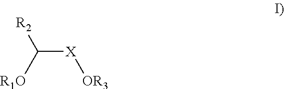
where
a) R¹, R², and R³ each independently of one another are H or an alkyl, alkoxy or alkanol group having 1-8 carbon atoms; and
b) X is a substituted or unsubstituted alkylene group having 1-8 carbon atoms.

2. The method as claimed in claim 1, wherein the at least one glycol compound is selected from the group consisting of ethylene glycol, diethylene glycol, propylene glycol, dipropylene glycol, butyl diglycol, neopentyl glycol, and hexylene glycol.

3. The method as claimed in claim 2, wherein the at least one glycol compound is selected from propylene glycol, dipropylene glycol, and butyl diglycol.

4. The method as claimed in claim 3, wherein the at least one glycol compound is selected from dipropylene glycol and butyl diglycol.

5. The method as claimed in claim 1, wherein the at at least one glycol compound is used for reducing vibration of the roller mill.

6. The method -t-t&e as claimed in claim 1, wherein the at least one glycol compound is used to stabilize a grinding bed of the roller mill.

7. The method as claimed in claim 1, wherein the at least one glycol compound is used for boosting the productivity of the roller mill and/or for increasing the fineness of grind of the at least one solid.

8. The method as claimed in claim 1, wherein the at least one glycol compound is employed together with at least one further additive, the further additive being selected the group consisting of grinding aids, defoamers, dyes, preservatives, plasticizers, superplasticizers, accelerators, retarders, air entrainers, shrinkage reducers and corrosion inhibitors.

9. The method as claimed in claim 8, wherein the further additive comprises at least one of the following representatives:
a) one or more amino alcohols and/or salts thereof,
b) one or more glycols and/or glycol derivatives,
c) one or more polycarboxylates and/or polycarboxylate ethers.

10. The method as claimed in claim 1, wherein the solid comprises a mineral binder and/or an adjuvant for a mineral binder.

11. The method as claimed in claim 1, wherein the solid comprises at least 5 wt % of a hydraulic binder.

12. The method as claimed in claim 1, wherein the solid to be ground is admixed, before and/or during grinding, with the at least one glycol compound.

13. A grinding aid composition comprising
a) at least one glycol compound,
and
b) at least one further additive which is selected from the group selected from the group consisting of grinding aids, defoamers, dyes, preservatives, plasticizers, superplasticizers, accelerators, retarders, air entrainers, shrinkage reducers and/or and corrosion inhibitors, wherein
the at least one further additive is chemically distinguishable from the at least one glycol compound, and
the at least one glycol compound has a structure as per formula I: 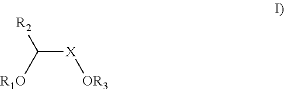
where
R1, R2. and R3 each independently of one another are H or an alkyl, alkoxy or aikanol group having 1-8 carbon atoms, and
X is a substituted or unsubstituted alkylene group having 1-8 carbon atoms.

14. A composition comprising a solid and at least one glycol compound, the at least one glycol compound having a structure as per formula I: 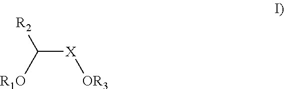
where
R1, R2. and R3 each independently of one another are H or an alkyl, alkoxy or alkanol group having 1-8 carbon atoms; and
X is a substituted or ⁻in/substituted alkylene group having 1-8 carbon atoms.

15. The grinding aid composition as claimed in claim 13, wherein the at least one glycol compound is selected from the group consisting of propylene glycol, dipropylene glycol, and butyl diglycol.

16. A composition obtainable by a method as claimed in claim 12.
